(19) United States
(12) Patent Application Publication
(10) Pub. No.: US 2011/0138756 A1
(43) Pub. Date: Jun. 16, 2011

(54) Gas Filter System

(75) Inventors: Theo Risse, Werne (DE); Meinrad Wilhelm Hubertus Wolff, Bocholt (DE)

(73) Assignee: HAMON ENVIROSERV GMBH, Essen (DE)

(21) Appl. No.: 13/001,414

(22) PCT Filed: Jun. 20, 2009
(86) PCT No.: PCT/EP2009/004470

§ 371 Date: Jan. 26, 2011

(30) Foreign Application Priority Data
Jun. 25, 2008 (DE) 20 2008 008 464.4

(51) Int. Cl. B01D 46/04

(52) U.S. Cl. 55/294

(57) ABSTRACT

The invention relates to a gas filter system having a plurality of tubes being suspended at one end at a carrier plate in a filter chamber that is flowed through by gas, said tubes having a lateral surface made from a filter material, said tubes being flowed through radially from the outside to the inside by a gas to be filtered, and guiding the gas filtered in this manner to a collecting space formed above the carrier plate, wherein openings formed by the tube ends for accommodating the carrier plate are disposed in a circular surface of the carrier plate.

The present invention relates to a gas filter system having a plurality of tubes suspended at one end on a carrier plate in a filter chamber through which gas flows, which tubes have a lateral surface made from a filter material.

Such filter systems are known from the prior art. An essentially cylindrical chamber is formed by a filter housing. A carrier plate is arranged in the upper region of this chamber, which chamber is provided with a large number of openings. In each of the openings a tube consisting of a filter material, generally a textile tube, is suspended and projects into a filter chamber in the region below the carrier plate. Air to be purified or filtered is blown laterally into an inflow opening in the filter chamber, flows through the lateral surface of the tubes and thus the filter material from the outside to the inside, in order then to be conducted away upwards through the openings in the carrier plate in the interior of the tubes. Impurities, dust and the like then remain on the outside of the tubes. To prevent the tubes from collapsing, they are reinforced with internal, basket-like frames. It is quite obvious that such filter tubes must be cleaned. To this end, it is known to blow pressurised air from above into the openings through the carrier plate and into the tube. This then causes the filter cake to fall off into a region below the filter tube where the impurities are conducted away.

It is known to arrange nozzles for blowing air on bar-like units which are guided in a rotary manner over the upper surface of the carrier plate and thus the openings situated there. In order to ensure that air is always blown into an opening, the cross section of the openings and also the cross section of the tube baskets is oval-shaped. It is thus essentially ensured that in every position of a nozzle or blowing bar every opening is passed over in some way. As the bar rotates essentially about the centre point of the carrier plate, in which the openings are arranged in an essentially circular or oval manner, the oval openings are always arranged transversely to the radial in order to ensure that they are blown into reliably. Furthermore, extremely dense tube filter packing can be produced in this manner.

Although it is ensured in this manner that each opening is always somehow passed over by a nozzle for blowing in purification air to some extent, a very disadvantageous non-uniform distribution of the purification air is produced, both in relation to the rows of tubes and in that webs between the tube openings are blown at. The cleaning of the tubes by blowing in air is thus uncontrolled and undefined.

For maintenance purposes, a very high collecting space for the clean gas must be formed above these carrier plates, as the space must be at least so high that a customary tube basket length can be pulled upwards, for example to replace a filter tube, to be able to clean it in the event of excessive dirt, or the like.

It is also known in the prior art for an arrangement as described to be essentially rectangular. In this case it is then possible to form a maintenance floor which is safe to walk on above the carrier plate, individual segments of which floor can be removed so that each individual tube opening can be accessed. In the known prior art it would not be possible to arrange a covering plate without a row of openings always being in the boundary region between two covers, so that it would not be possible to maintain these openings.

The described arrangements belonging to the prior art also have disadvantages with regard to gas flow. As the gas ducts are delimited by the very dense arrangement of a multiplicity of tubes situated in an oval transversely to the gas flow, that is, transversely to the radial, the gas flow path basically meanders around the tubes. Although this is desirable with regard to the filter effect, because many filtering surfaces are passed over in this manner, the tube filters become unevenly dirty, that is in particular from the outside to the inside in relation to the circular carrier surface, and the meandering flow path inhibits the flowing gas. The performance of these filters is correspondingly limited for this reason. An undesirably high pressure loss is also produced in the gas chamber by the meandering of the gas through the rows of cleaning tubes.

A generic flue gas purification system or gas filter system is known for example from U.S. Pat. No. 4,157,899. In that document, transversely lying oval openings are arranged on a circular ring surface. To remove the individual filter tubes, very specific suspension systems must be used and the space must be wide open towards the top. A continuously running cleaning unit sprays air randomly into the tubes.

DE 34 20 211 discloses the use of round tube filter units, but these are introduced into individual segments separated by side walls. A comparable arrangement is disclosed in FR 2 719 497 A1.

Proceeding from the above-described prior art, the present invention is based on the object of improving a gas filter system of the generic type so that the gas flow paths are simplified, it is possible for the cleaning gas to be blown out of the nozzles in an improved and reliable manner and also maintenance is improved.

For the technical solution of this object, a gas filter system with the features of the claim 1 is proposed. Further advantages, features and independent inventions can be found in the subclaims and the description below.

According to an essential and independent aspect of the present invention, the openings formed in the carrier plate for accommodating the tube ends are arranged in a circular surface of the carrier plate in such a manner that these openings lie in predefined divisions of the circular surface on a radially running line. This means that openings which are always aligned in the same direction according to a predefined division run consecutively along a radial jet from a given circular surface inner ring to a given circular surface outer edge. Such a division can be between 5° and 45°, it is preferably 15°. That is, there is a row of openings along a line every 15°. The circular surface is thereby segmented. In the adjacent surfaces of each segment, the openings are then likewise arranged and aligned along radial lines, but offset such that they partly intersect over the radial distance in each case. This means that largely straight flow paths which meander very little or are almost completely uninterrupted are formed for the gas to be cleaned between the tubes suspended in the openings. In this manner, not only are the outer cleaning tubes loaded in particular, but all the tubes are loaded largely uniformly. If oval openings are used, they are aligned along the radial, not transversely as in the prior art. The openings can on the basis of the invention have any desired cross section according to its merits, as can the tube baskets. This is because cleaning arms can be created by the segmentation according to the invention, which arms can be configured to hit all the openings in a segment clearly every time. Cleaning nozzles which are connected to corresponding cleaning air supplies are advantageously arranged by means of carrier arms in such a manner that they pass over the circular surface while rotating about the centre point of the circular carrier surface. The nozzles are positioned differently if there are different arms. That is, each arm passes over a certain number or group of openings in a segment. If all four arms have passed over a segment, all the openings have clearly been exposed once to cleaning air. The configuration according to the invention ensures that each filter tube is loaded with equal amounts of cleaning air per unit time, so that in contrast to the prior art extremely controlled and defined cleaning is produced.

The segmentation also means that there is, projected vertically upwards, an unambiguous surface region for each segment of openings, which ensures that the tube of each opening within these projection surfaces can be pulled upwards unimpeded. This effect of the teaching according to the invention ensures that a maintenance floor can be inserted just above the carrier surface, in which floor circular segment-shaped, removable floor plates are arranged. If such a floor plate is removed, it is ensured that all the openings situated thereunder can be reached and all the tubes of each opening situated thereunder can be pulled out upwards through the maintenance floor unimpeded. In other words, there are no openings which lie in a section between maintenance floors and therefore cannot be pulled out. The floor plates can have a multi-part configuration.

It is thereby possible to keep the clean gas chamber above the carrier plate very low, for example 40 cm or 50 cm high, so that the filter arrangement as a whole becomes more compact.

The gas filter system, consisting of the tube filters, the carrier plate, the clean gas chamber situated above it and the maintenance floor, is advantageously arranged in a filter housing which, in correspondence with the circular surface of the carrier plate, is preferably circular-cylindrical.

According to a further essential and likewise independent aspect of the present invention, it is proposed for a gas inlet guide to be provided, through which the gas to be cleaned flows into the filter chamber in a tangential direction. This produces a large number of advantages. Firstly, the gas is not directed directly at a frontal tube filter surface, so that such a tube filter group is prevented from being loaded particularly greatly, rather, the gas flows very calmly tangentially in the cylindrical filter chamber, spreads over the entire inner circumference and enters the tube filter groups much more uniformly, any dust or other residues which accumulate in the wall region at the same time falling downwards into the region of a dust collector or dust removal funnel.

In the cleaning systems known from the prior art, one or two arms fitted with nozzles travel at a constant speed over the circular surfaces provided with openings in order to blow pressurised air into the openings and thus the filters. The nozzles pass over openings and edge regions in between. The prior art has proposed with respect to this, for example, for pressurised air valves to be controlled in such a manner that the pressurised air is only sent into the nozzles when they are over an opening. Such a control system is complex and requires a considerable sensor system. The other systems known from the prior art accept corresponding pressure losses, poor cleaning and the like. The present invention advantageously proposes for the drive of the cleaning system to be configured as an electrical and controllable drive. In this manner it is possible comparatively simply to move the cleaning system at different speeds depending on the application, dust accumulation on the filter elements and need and, in particular to move it particularly slowly over the region with the openings and quickly in the edge regions. The system can also be stopped over openings to allow thorough cleaning. It can then be moved comparatively quickly to the next openings. As the circular surfaces are segmented according to the present invention, very simple position controls can be used, that is, the respective angle position can be detected in a simple manner. The control system can advantageously also allow the cleaning system to be moved into predefined positions in order to clean particularly dirty positions with a long application of pressurised air.

Different aspects according to the invention are proposed which considerably improve in particular the maintenance, cleaning, service life and efficiency of corresponding gas filter systems. Each of the aspects is patentable considered separately.

Further advantages and features of the invention can be found in the description below using the figures. In the figures:

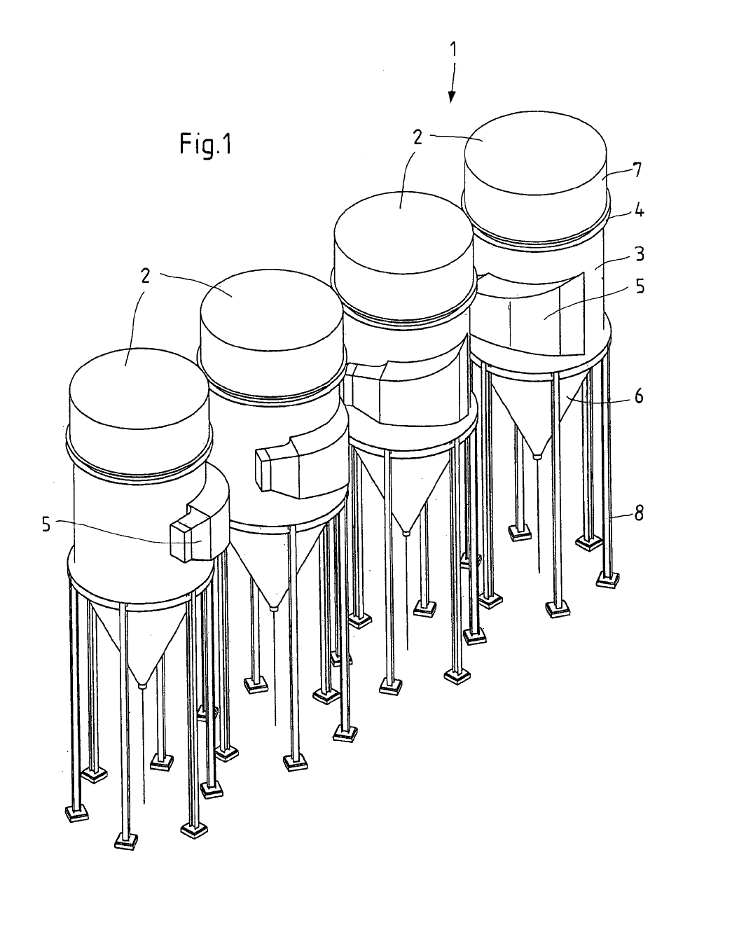

FIG. 1 shows a perspective illustration of a group of gas filter systems;

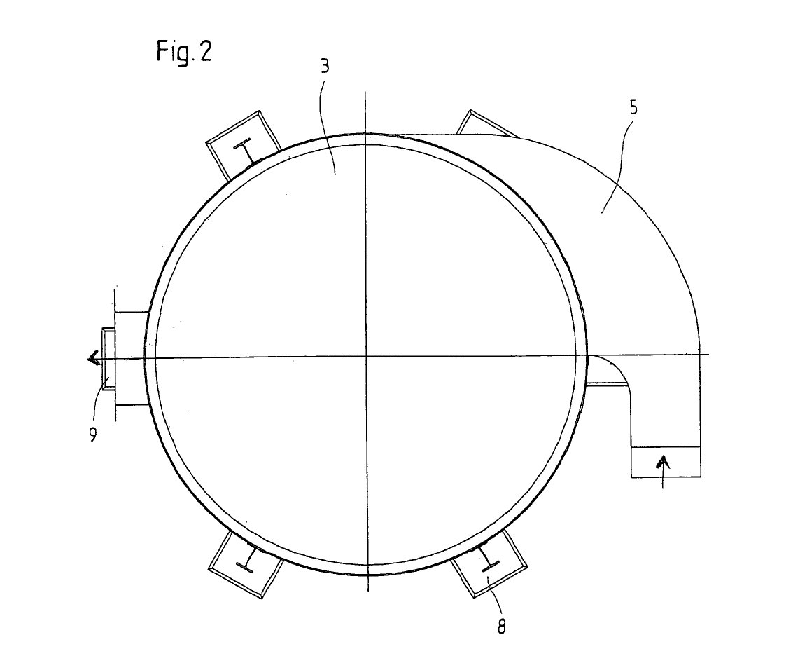

FIG. 2 shows a plan view of a housing of a gas filter system;

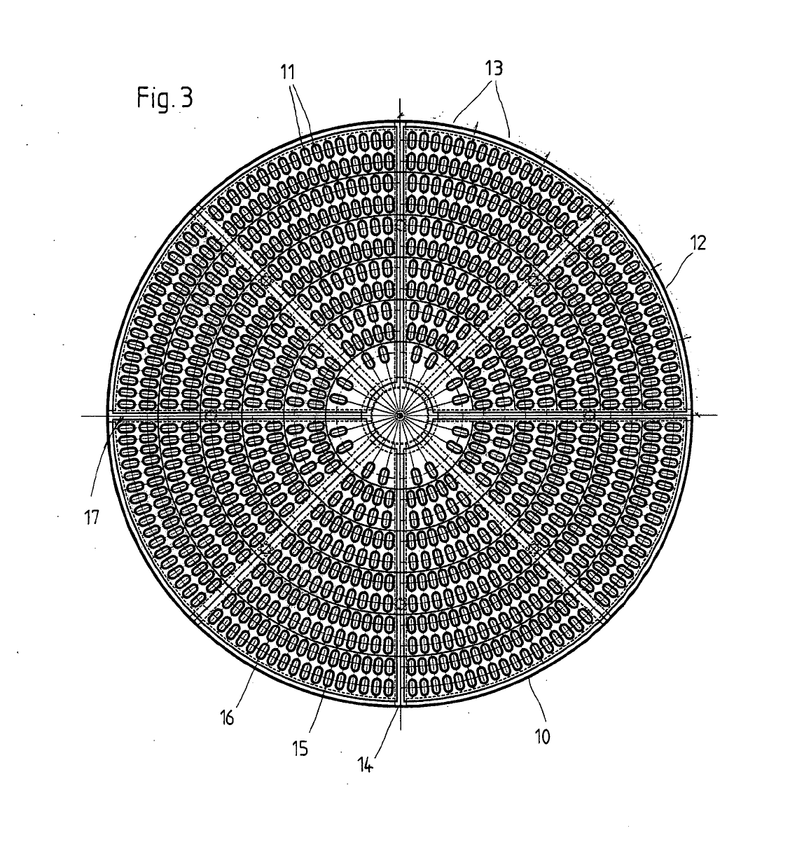

FIG. 3 shows a plan view of a carrier plate with an opening arrangement according to the invention;

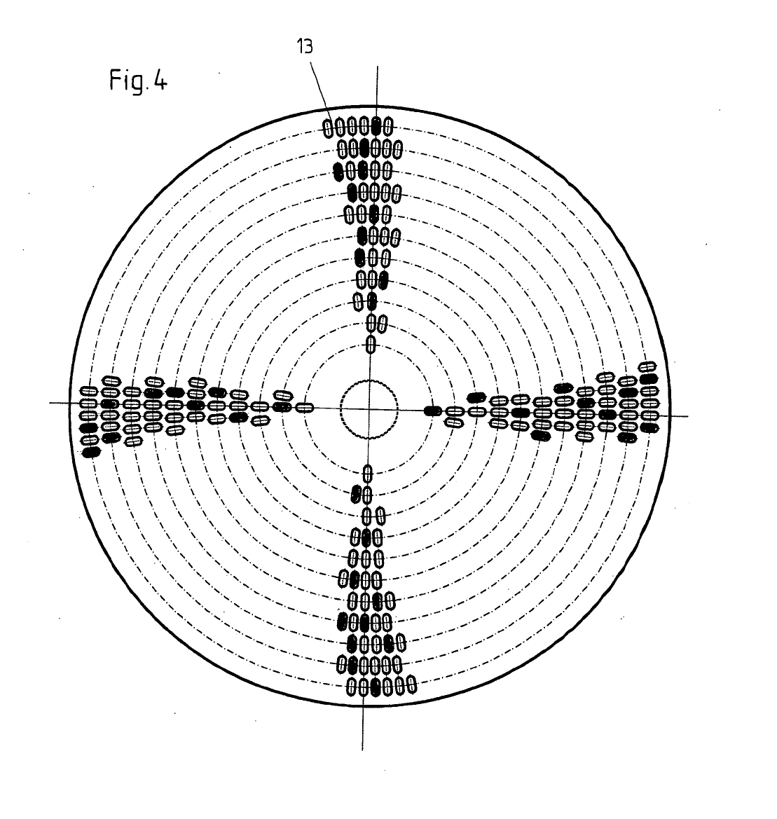

FIG. 4 shows an illustration corresponding to FIG. 3 of the segments passed over by cleaning arms;

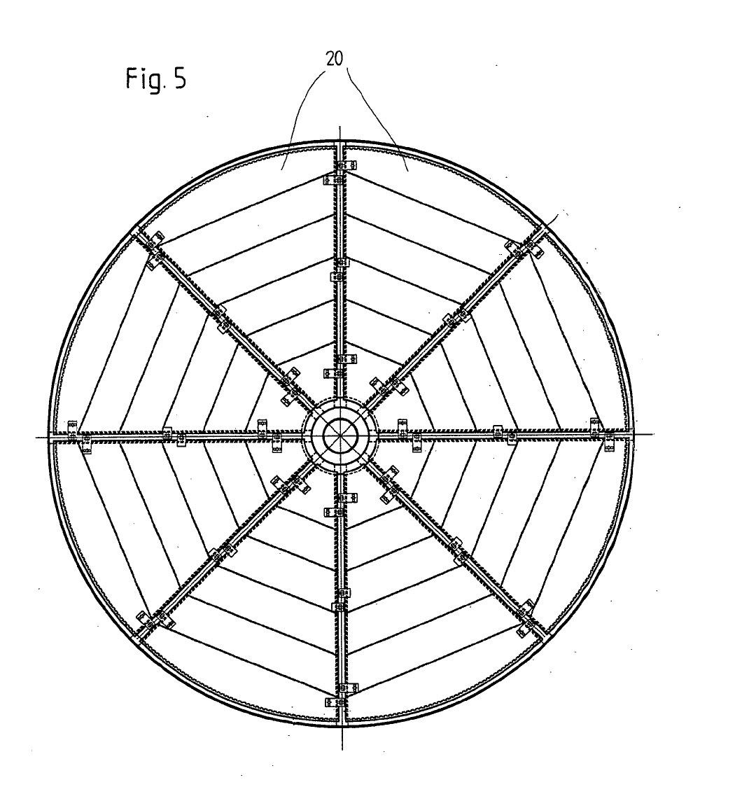

FIG. 5 shows a plan view of a maintenance floor and

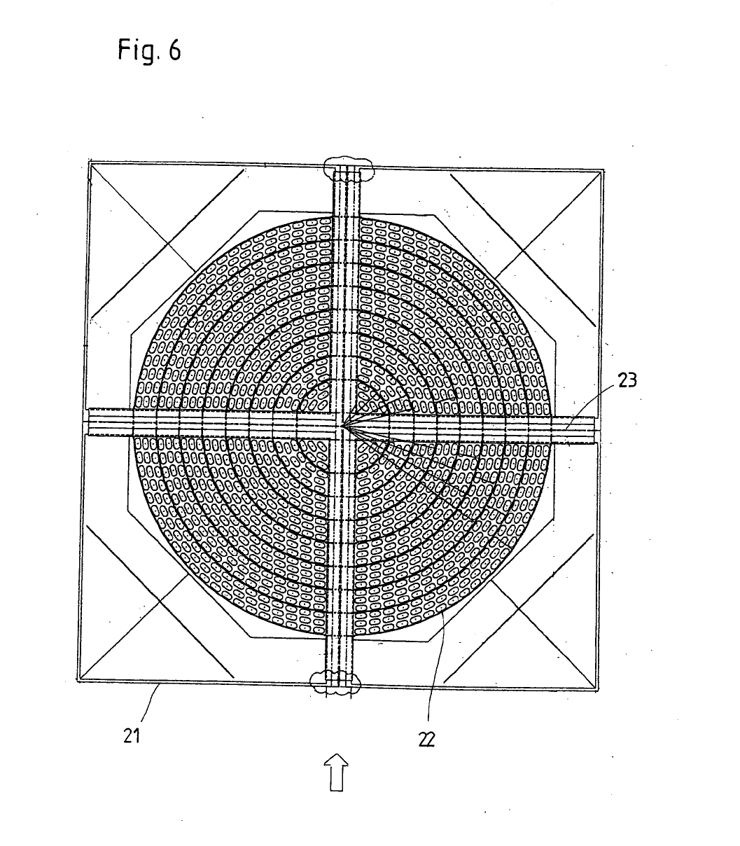

FIG. 6 shows a plan view of a carrier plate arrangement according to the prior art.

FIG. 1 shows a filter group 1, in which individual gas cleaning units 2 are set up. Each of these units comprises a cylindrical housing which has a filter chamber 3, a region of the carrier plate 4 over which the clean gas chamber/maintenance chamber arrangement 7 is situated and a collection and removal funnel 6 for impurities. In the exemplary embodiment shown, tangentially feeding inflow inlets 5 are shown. It can be seen in particular in FIG. 2 that these feed the gas to be cleaned very gently tangentially into the chamber, in which filter chamber 3 the tube filters are suspended. The air flow is therefore tangentially calmed, and the gas outlet 9 is in the upper region. In the exemplary embodiment shown, the units are arranged on stilts 8.

FIG. 3 shows an exemplary embodiment of a carrier plate according to the invention. The carrier plate does not absolutely have to be round, that is, it can have an angle or a plurality of angles, an oval or other configuration. In any case, the region of the suspension openings for the tube filters is a circular surface. The plate 10 is provided with the openings 11 which in the exemplary embodiment shown are oval and arranged in the longitudinal direction with respect to the radial. The openings 11 are positioned in fields 12, which is a 45° region in the exemplary embodiment shown, which are in turn subdivided into individual segments 13. This segmentation is produced by the arrangement of in each case radially running rows of openings 14, 15 and 16, which run on a radial line from the outer to the inner ring. The arms of cleaning devices 17 are arranged so that they can move about the centre point of the plate and have nozzles, by means of which pressurised air is blown into the openings.

FIG. 4 shows an exemplary embodiment for an arrangement of four cleaning arms with different nozzle patterns. One arm covers a 15° segment and with its nozzles covers a certain pattern of openings. Each arm covers a different pattern. If all four arms have passed over a 15° segment, all the openings have automatically been completely loaded with cleaning air.

FIG. 5 shows by way of example a maintenance floor which is circular and is arranged directly above the carrier plate, for example at a distance of 40 cm. The configuration of the radial arrangement of the openings makes it possible to arrange segment-shaped floor plates 20. If such a plate segment 20, which can if necessary consist of a plurality of parts, is lifted, an exactly 45° region of the carrier plate is revealed. Each visible opening can be managed vertically, so that tube filter introduced into it can be pulled out vertically upwards.

FIG. 6 shows an embodiment 20 belonging to the prior art for a carrier plate arrangement wherein the carrier plate has openings 22 for tube filters. These are ovals arranged transversely to the radial, so that cleaning air can be blown at least into each opening in some way when the cleaning arms 23 pass over, as when this arm arrangement rotates, at least each opening comes into the region of a cleaning air nozzle with part of its oval projection surface.

The described exemplary embodiments only serve for explanation and are not limiting.

### LIST OF REFERENCE SYMBOLS

1 Filter arrangement
2 Filter unit
3 Filter chamber
4 Carrier plate
5 Air inlet
6 Removal funnel
7 Clean gas/maintenance chamber
8 Stilts
9 Gas outlet
10 Carrier plate
11 Openings
12 Main segment
13 Individual segment
14 Radial row
15 Radial row
16 Radial row
17 Cleaning arm
20 Cover plate
21 Carrier plate arrangement
22 Carrier plate opening
23 Cleaning arm

What is claimed is:

1.-10. (canceled)

11. A gas filter system comprising:
a filter chamber through which gas to be filtered flows;
a carrier plate disposed on said filter chamber;
a clean gas chamber disposed above said carrier plate;
a plurality of tubes each having an end suspended from said carrier plate and arranged in said filter chamber, said tubes having a lateral surface consisting of a filter material;
wherein said carrier plate comprises openings for receiving said ends of said tubes;
wherein the gas to be filtered flows through said tubes radially from an outside to an inside of said tubes and said tubes guide the gas from said inside into said clean gas chamber;
wherein said openings in said carrier plate are arranged at a predefined division of a circular surface of said carrier plate and extend consecutively along a radial line from an inner ring of said circular surface to an outer edge of said circular surface such that said openings are always aligned in the same direction;
a cleaning system comprising at least two cleaning arms provided with cleaning gas nozzles, wherein said cleaning gas nozzles are arranged in different positions on different ones of said arms;
wherein said cleaning arms rotate around a center of said circular surface and position said cleaning gas nozzles over at least some of said openings.

12. A gas filter system according to claim 11, wherein said predefined division of said circular surface of said carrier plate is between 5 and 45 degrees.

13. A gas filter system according to claim 12, wherein said predefined division of said circular surface of said carrier plate is 15 degrees.

14. A gas filter system according to claim 11, wherein said openings are oval and are arranged along radii of said circular surface.

15. A gas filter system according to claim 11, wherein above said clean gas chamber a maintenance chamber is arranged.

16. A gas filter system according to claim 15, wherein said maintenance chamber has a floor region that is positioned above said circular surface of said carrier plate and is comprised of movable plates in the form of circular segments, said circular segments, taken together, are positioned essentially over said circular surface of said carrier surface such that said tubes received in said openings of said carrier plate can be pulled out vertically in upward direction.

17. A gas filter system according to claim 16, wherein said moveable plates have a multi-part configuration.

18. A gas filter system according to claim 11, comprising a gas inlet guide through which the gas to be filtered flows tangentially into said filter chamber.

19. A gas filter system according to claim 11, wherein said cleaning arms each cover a 15° segment of said openings of said carrier plate.

20. A gas filter system according to claim 11, wherein said cleaning arms each cover a defined pattern of said openings on said carrier plate.

21. A gas filter system according to claim 11, wherein said cleaning system has a controllable electrical drive.

22. A gas filter system according to claim 21, comprising a control unit controlling a speed of said cleaning system depending on a position of said cleaning system.
